(19) United States
(12) Patent Application Publication
(10) Pub. No.: US 2025/0210293 A1
(43) Pub. Date: Jun. 26, 2025

(54) ELECTROMAGNETIC RELAY

(71) Applicant: Toyota Jidosha Kabushiki Kaisha, Toyota-shi (JP)

(72) Inventors: Takashi USHIJIMA, Nagoya-shi (JP); Akihito TSUKAMOTO, Toyota-shi (JP)

(73) Assignee: TOYOTA JIDOSHA KABUSHIKI KAISHA, Toyota-shi (JP)

(21) Appl. No.: 18/958,194

(22) Filed: Nov. 25, 2024

(30) Foreign Application Priority Data
Dec. 20, 2023 (JP) 2023-214399

(51) Int. Cl. H01H 50/12

(52) U.S. Cl. CPC H01H 50/12

(57) ABSTRACT

An electromagnetic relay includes a functional unit configured to execute an electromagnetic relay process, a plate having a flat shape, the functional unit being mounted on the plate, and a case having a box shape and covering the functional unit when fitted to the plate. The case has a ventilation route at a fitting part that contacts with the plate when the case is fitted to the plate, the ventilation route communicating an inside of the electromagnetic relay, in which the functional unit is present, with an outside of the electromagnetic relay.

### CROSS-REFERENCE TO RELATED APPLICATION

This application claims priority to Japanese Patent Application No. 2023-214399 filed on Dec. 20, 2023, incorporated herein by reference in its entirety.

### BACKGROUND

### 1. Technical Field

The disclosure relates to an electromagnetic relay.

### 2. Description of Related Art

WO 2013/002154 describes an electromagnetic relay mounted on a vehicle or the like. In this electromagnetic relay, vents are provided in slits of a case member (base), through which coil terminals and contact terminals are inserted, and water vapor generated in an internal space of the electromagnetic relay is released through the vents. Thus, an increase in moisture inside the electromagnetic relay is suppressed.

### SUMMARY

The electromagnetic relay described in WO 2013/002154 has a structure in which the vents are provided at the slits of the case member, through which the terminals are inserted. For this reason, installation locations of the vents are limited, so the number of vents is small (four locations). If a vent area is attempted to be increased to increase ventilation efficiency in this vent structure, each of the vents increases in size, which leads to easy entry of foreign matter, such as bugs and dust, into the electromagnetic relay. In addition, since the vents are provided in the slits of the case member, through which terminals are inserted, if contaminants, such as grease and silicone, adhere to the terminals, the adherent contaminants presumably flow (climb) along the terminals and easily enter the electromagnetic relay through the vents.

Such foreign matter or contaminants having entered the electromagnetic relay may affect the function of the electromagnetic relay to bring about trouble, such as contact failure. Therefore, there is room for further consideration in formation of a ventilation route in an electromagnetic relay.

The disclosure provides an electromagnetic relay capable of effectively releasing moisture inside the electromagnetic relay to outside while suppressing entry of foreign matter or contaminants into the electromagnetic relay.

A first aspect of the disclosure provides an electromagnetic relay including a functional unit configured to execute an electromagnetic relay process, a plate having a flat shape, the functional unit being mounted on the plate, and a case having a box shape and covering the functional unit when fitted to the plate. The case has a ventilation route at a fitting part that contacts with the plate when the case is fitted to the plate, the ventilation route communicating an inside of the electromagnetic relay, in which the functional unit is present, with an outside of the electromagnetic relay.

A second aspect of the disclosure provides an electromagnetic relay including a functional unit configured to execute an electromagnetic relay process, a plate having a flat shape, the functional unit being mounted on the plate, and a case having a box shape and covering the functional unit when fitted to the plate. The plate has a first groove, the case has a second groove, and a ventilation route is provided by combining the first groove with the second groove when the plate and the case are fitted to each other, the ventilation route communicating an inside of the electromagnetic relay, in which the functional unit is present, with an outside of the electromagnetic relay.

A third aspect of the disclosure provides an electromagnetic relay including a functional unit configured to execute an electromagnetic relay process, a plate having a flat shape, the functional unit being mounted on the plate, and a case having a box shape and covering the functional unit when fitted to the plate. The plate has a ventilation route at a step with which the case contacts when the plate is fitted to the case, the ventilation route communicating an inside of the electromagnetic relay, in which the functional unit is present, with an outside of the electromagnetic relay.

In the above aspect, the ventilation route may have a distance longer than a shortest distance between the inside of the electromagnetic relay and the outside of the electromagnetic relay.

In the above aspect, the ventilation route may be made up of a nonlinear path.

In the above aspect, the ventilation route may be preferentially provided near an electromagnetic coil that is a component of the functional unit.

In the above aspect, a passage size of the ventilation route at least at one location may be less than 0.1 mm.

With the electromagnetic relay according to the above aspect of the disclosure, it is possible to effectively release moisture inside the electromagnetic relay to outside while suppressing entry of foreign matter or contaminants into the electromagnetic relay.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1A is a front view of an electromagnetic relay according to a first embodiment of the disclosure;

FIG. 1B is a side view of the electromagnetic relay according to the first embodiment of the disclosure;

FIG. 2A is a sectional view of the electromagnetic relay, taken along the line IIA-IIA in FIG. 1A;

FIG. 2B is a sectional view of the electromagnetic relay, taken along the line IIB-IIB in FIG. 1A;

FIG. 3A is a front view of an electromagnetic relay according to a second embodiment of the disclosure;

FIG. 3B is a side view of the electromagnetic relay according to the second embodiment of the disclosure;

FIG. 4A is a sectional view of the electromagnetic relay, taken along the line IVA-IVA in FIG. 3A;

FIG. 4B is a sectional view of the electromagnetic relay, taken along the line IVB-IVB in FIG. 3A;

FIG. 5A is a front view of an electromagnetic relay according to a third embodiment of the disclosure;

FIG. 5B is a side view of the electromagnetic relay according to the third embodiment of the disclosure;

FIG. 6A is a sectional view of the electromagnetic relay, taken along the line VIA-VIA in FIG. 5A;

FIG. 6B is a sectional view of the electromagnetic relay, taken along the line VIB-VIB in FIG. 5A;

FIG. 7 is a front view of an electromagnetic relay according to a first modification of the first embodiment of the disclosure; and

FIG. 8 is a front view of an electromagnetic relay according to a second modification of the first embodiment of the disclosure.

### DETAILED DESCRIPTION OF EMBODIMENTS

In an electromagnetic relay according to the disclosure, in a state where a case covering a functional unit that executes an electromagnetic relay process is fitted to a plate on which the functional unit is mounted, a ventilation route that communicates an inside of the electromagnetic relay with an outside of the electromagnetic relay is provided at a joint area between the plate and the case. Thus, moisture inside the electromagnetic relay is easily released to outside the electromagnetic relay while entry of foreign matter or contaminants is suppressed. Hereinafter, embodiments of the disclosure will be described in detail with reference to the accompanying drawings.

### First Embodiment

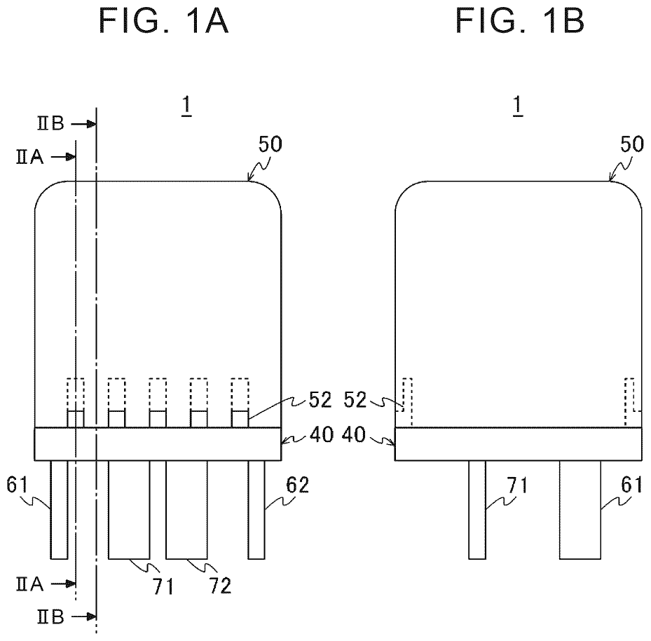

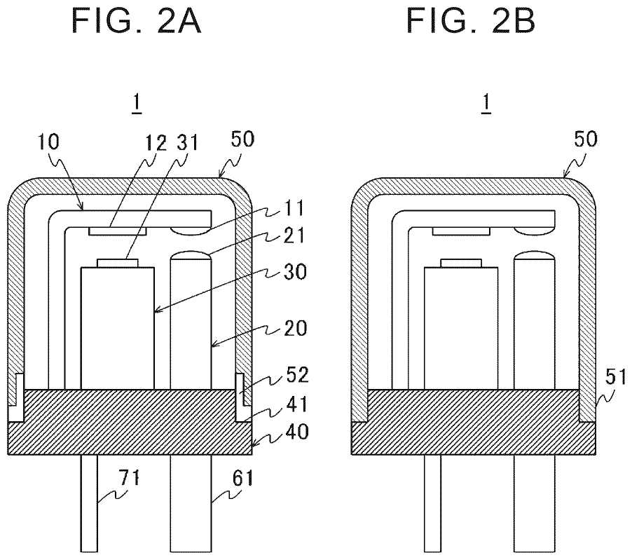

FIG. 1A is a front view of an electromagnetic relay 1 according to a first embodiment of the disclosure when viewed from the surface. FIG. 1B is a side view of the electromagnetic relay 1 according to the first embodiment of the disclosure when viewed from the surface. FIG. 2A is a sectional view of the electromagnetic relay 1, taken along the line IIA-IIA in FIG. 1A. FIG. 2B is a sectional view of the electromagnetic relay 1, taken along the line IIB-IIB in FIG. 1A.

The electromagnetic relay 1 illustrated in FIG. 1A, FIG. 1B, FIG. 2A, and FIG. 2B is a switch component for switching action of electrical contacts by using electromagnetic force. The electromagnetic relay 1 includes a movable contact part 10, a fixed contact part 20, an electromagnetic coil 30, a plate 40, a case 50, load terminals 61, 62, and coil terminals 71, 72.

The movable contact part 10 is, for example, a member having an L-shape in cross section and made of a material having flexibility and electrical conductivity. The movable contact part 10 includes a movable contact 11 provided at one end and a ferromagnetic substance 12 provided at a location opposed to the electromagnetic coil 30. The movable contact part 10 is mounted on one flat surface of the plate 40 in a state where the other end is fixed to the plate 40. The movable contact part 10 is electrically connected to the load terminal 61 provided so as to protrude from the other flat surface of the plate 40.

The fixed contact part 20 is, for example, a member having an I-shape in cross section and made of a material having electrical conductivity. The fixed contact part 20 includes a fixed contact 21 provided at one end. The fixed contact part 20 is mounted on one flat surface of the plate 40 in a state where the other end is fixed to the plate 40. The fixed contact part 20 is electrically connected to the load terminal 62 provided so as to protrude from the other flat surface of the plate 40.

The electromagnetic coil 30 is an electromagnet capable of generating magnetic force when current is passed through a coil wound around a magnetic substance. The electromagnetic coil 30 includes a core 31 provided at a location opposed to the ferromagnetic substance 12 of the movable contact part 10. The electromagnetic coil 30 is mounted on one flat surface of the plate 40 in a state where the electromagnetic coil 30 is fixed to the plate 40. In the electromagnetic coil 30, one end of the coil is electrically connected to the coil terminal 71 provided so as to protrude from the other flat surface of the plate 40, and the other end of the coil is electrically connected to the coil terminal 72 provided so as to protrude from the other flat surface of the plate 40.

The movable contact part 10, the fixed contact part 20, and the electromagnetic coil 30 make up a functional unit that executes an electromagnetic relay process. In the functional unit, once the electromagnetic coil 30 is energized via the coil terminals 71, 72, attraction force toward the core 31 acts on the ferromagnetic substance 12. Due to this attraction force, one end of the movable contact part 10 deflects toward one end of the fixed contact part 20, and the movable contact 11 and the fixed contact 21 contact with each other. As a result, the movable contact part 10 and the fixed contact part 20 becomes electrically continuous, and the load terminal 61 and the load terminal 62 are electrically connected.

The plate 40 is a member having substantially a rectangular plate shape in a top view and made of a material, such as a resin, having electrical insulating properties. The movable contact part 10, the fixed contact part 20, and the electromagnetic coil 30 are mounted on a first flat surface (upper surface) of the plate 40. The load terminal 61, the load terminal 62, the coil terminal 71, and the coil terminal 72 are provided on a second flat surface (lower surface) of the plate 40 so as to be allowed to be electrically joined with another component. A step 41 with a predetermined depth for being fitted to the case 50 is provided at the outer periphery of the first flat surface of the plate 40.

The case 50 is a member having substantially a box shape with one side open and made of a material, such as a resin, having electrically insulating properties. The case 50 plays a role in enclosing the movable contact part 10, the fixed contact part 20, and the electromagnetic coil 30 in an internal space formed by the plate 40 and the case 50 when a fitting part 51 that is an end of an opening plane is brought into contact with the step 41 of the plate 40 and fitted to the plate 40. With this structure, it is possible to reduce contact of the movable contact part 10, the fixed contact part 20, and the electromagnetic coil 30 with foreign matter or contaminants.

The case 50 according to the first embodiment, in addition to the above-described structure, further includes a ventilation route 52 for releasing moisture generated in the internal space formed by the plate 40 and the case 50 (hereinafter, referred to as “inside of the electromagnetic relay 1”) to outside the electromagnetic relay 1. The ventilation route 52 is made up of a hole (vent) formed by cutting part of the fitting part 51 of the case 50 into a U-shape and a cutout groove extending from the hole along an inner surface of the case 50 by the length greater than the thickness of the plate 40 in a state where the case 50 is fitted to the plate 40. With the presence of the ventilation route 52, it is possible to release moisture generated inside the electromagnetic relay 1 to outside by communicating the inside of the electromagnetic relay 1 with the outside of the electromagnetic relay 1 in a state where the functional unit that executes the electromagnetic relay process is protected by the case 50 from foreign matter or contaminants.

In FIG. 1A, FIG. 1B, FIG. 2A, and FIG. 2B, an example in which the ventilation route 52 is provided at two opposite sides out of four sides of the case 50, each side having the fitting part 51, is illustrated; however, the number of sides where the ventilation route 52 is provided, the location of each ventilation route 52, and the shape of each ventilation route 52 are not limited thereto. However, moisture inside the electromagnetic relay 1 is moisture absorbed by a coating film (enamel) or resin member of the electromagnetic coil 30 because of repetition of heating at the time of turning on energization of the electromagnetic coil 30 and cooling at the time of turning off energization. Thus, near the electromagnetic coil 30, a larger number of the ventilation routes 52 is desirably provided, or a larger area of each ventilation route 52 than the other part is desirably provided. In other words, ventilation for the electromagnetic coil 30 is given a higher priority than ventilation for the movable contact part 10 or the fixed contact part 20. Thus, moisture around the electromagnetic coil 30 is easily released. On the other hand, near the movable contact part 10 and the fixed contact part 20, the number of the ventilation routes 52 is preferably reduced or not provided or the area of each ventilation route 52 is preferably reduced than the other for the purpose of reducing occurrence of contact failure due to foreign matter or contaminants. Thus, it is possible to reduce a situation in which foreign matter or contaminants having entered through the ventilation route 52 reaches the contacts.

When a structure in which moisture is released by providing the ventilation route 52 is adopted, this provides an opportunity for foreign matter or contaminants to enter through the ventilation route 52. Of these, the electromagnetic relay 1 has no ventilation route 52 near these terminals against grease or contaminants, such as silicone, adhering to the load terminals 61, 62 or the coil terminals 71, 72, so there is presumably almost no possibility of entry. On the other hand, it is desirable to take measures for inhibiting entry of foreign matter, such as bugs, into the ventilation route 52. Examples of specific measures may include narrowing a passage size (hole or groove) of each ventilation route 52 at least at one location as compared to the height of a specific bug (for example, the height of scirtothrips dorsalis: about 0.1 mm) that may possibly enter the electromagnetic relay 1. With this structure, it is effective to reduce entry of Thysanoptera through the ventilation route 52.

As described above, in the electromagnetic relay 1 according to the first embodiment, the ventilation route 52 for releasing moisture from the inside of the electromagnetic relay 1 in a state where the plate 40 and the case 50 are fitted to each other is provided at the fitting part 51 of the case 50. With this structure, the number of the ventilation routes 52 installed can be increased, and it is easy to design and manufacture a die for the case 50. Furthermore, since no additional step is required in manufacturing the electromagnetic relay 1, it is possible to provide the electromagnetic relay 1 with a good ventilation characteristic at low cost.

### Second Embodiment

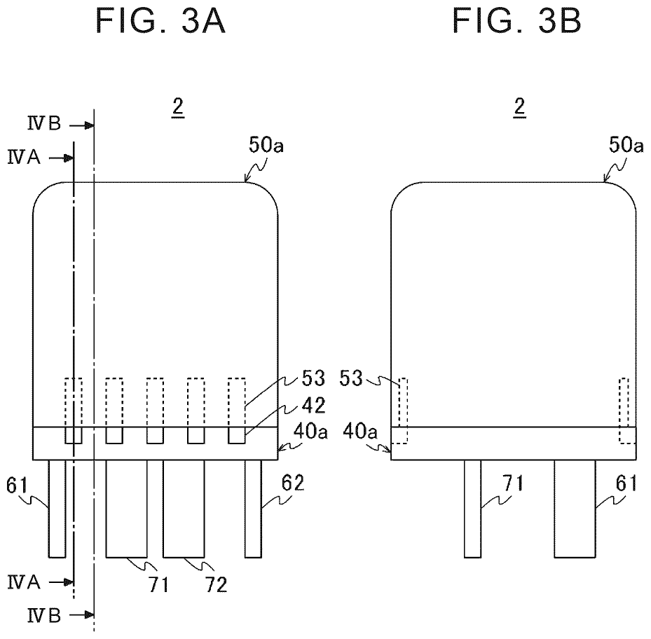

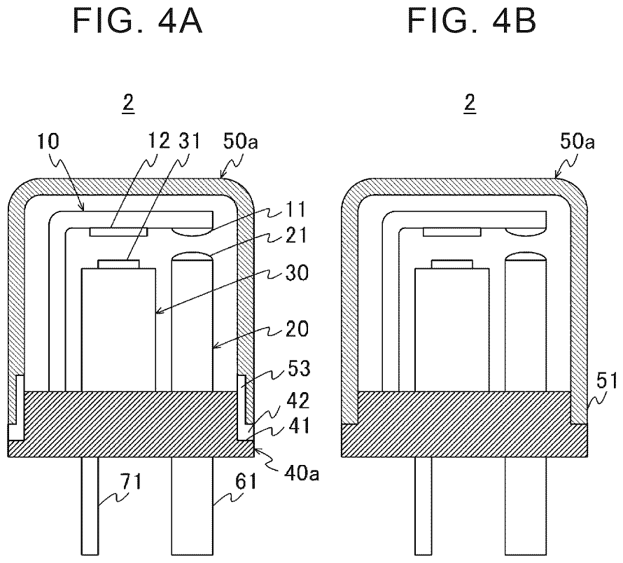

FIG. 3A is a front view of an electromagnetic relay 2 according to a second embodiment of the disclosure when viewed from the surface. FIG. 3B is a side view of the electromagnetic relay 2 according to the second embodiment of the disclosure when viewed from the surface. FIG. 4A is a sectional view of the electromagnetic relay 2, taken along the line IVA-IVA in FIG. 3A. FIG. 4B is a sectional view of the electromagnetic relay 2, taken along the line IVB-IVB in FIG. 3A.

The electromagnetic relay 2 illustrated in FIG. 3A, FIG. 3B, FIG. 4A, and FIG. 4B is a switch component for switching action of electrical contacts by using electromagnetic force. The electromagnetic relay 2 includes a movable contact part 10, a fixed contact part 20, an electromagnetic coil 30, a plate 40a, a case 50a, load terminals 61, 62, and coil terminals 71, 72.

The electromagnetic relay 2 according to the second embodiment differs from the electromagnetic relay 1 according to the first embodiment in the configurations of the plate 40a and the case 50a. Hereinafter, the description of the functional unit made up of the movable contact part 10, the fixed contact part 20, and the electromagnetic coil 30 each having the same configuration is omitted, and the description of the plate 40a and the case 50a each having a different configuration will be described.

The plate 40a is a member having substantially a rectangular plate shape in a top view and made of a material, such as a resin, having electrical insulating properties. The movable contact part 10, the fixed contact part 20, and the electromagnetic coil 30 are mounted on a first flat surface (upper surface) of the plate 40a. The load terminal 61, the load terminal 62, the coil terminal 71, and the coil terminal 72 are provided on a second flat surface (lower surface) of the plate 40a so as to be allowed to be electrically joined with another component. A step 41 with a predetermined depth for being fitted to the case 50a is provided at the outer periphery of the first flat surface of the plate 40a.

The case 50a is a member having substantially a box shape with one side open and made of a material, such as a resin, having electrically insulating properties. The case 50a plays a role in enclosing the movable contact part 10, the fixed contact part 20, and the electromagnetic coil 30 in an internal space formed by the plate 40a and the case 50a when a fitting part 51 that is an end of an opening plane is brought into contact with the step 41 of the plate 40a and fitted to the plate 40a. With this structure, it is possible to reduce contact of the movable contact part 10, the fixed contact part 20, and the electromagnetic coil 30 with foreign matter or contaminants.

The plate 40a and the case 50a according to the second embodiment, in addition to the above-described structure, each further include a groove for forming a ventilation route for releasing moisture generated inside the electromagnetic relay 2 to outside. The plate 40a has a cutout groove 42 (first groove) at part of the step 41. The case 50a has a cutout groove 53 (second groove) formed at part of the fitting part 51 and extending from the end of the opening plane by the length greater than the thickness of the plate 40a. The cutout groove 42 of the plate 40a and the cutout groove 53 of the case 50a are configured such that the locations of the grooves match each other in a state where the case 50a is fitted to the plate 40a and the cutout groove 42 and the cutout groove 53 make up a ventilation route. With the presence of the ventilation route, it is possible to release moisture generated inside the electromagnetic relay 2 to outside by communicating the inside of the electromagnetic relay 2 with the outside of the electromagnetic relay 2 in a state where the functional unit that executes the electromagnetic relay process is protected by the case 50a from foreign matter or contaminants.

Of course, in the electromagnetic relay 2 as well, the number of sides each having the cutout groove 42 and the cutout groove 53, and the locations and shapes of the cutout groove 42 and the cutout groove 53 are not limited to those shown in FIG. 3A, FIG. 3B, FIG. 4A, and FIG. 4B. It is also desirable to give a higher priority to ventilation for the electromagnetic coil 30 than ventilation for the movable contact part 10 or the fixed contact part 20 or to narrow the passage size of each ventilation route made up of the cutout groove 42 and the cutout groove 53 at least at one location as compared to the height of a specific bug.

As described above, in the electromagnetic relay 2 according to the second embodiment, the ventilation route for releasing moisture from the inside of the electromagnetic relay 2 in a state where the plate 40a and the case 50a are fitted to each other is provided by combining the cutout groove 42 (first groove) provided at the step 41 of the plate 40a and the cutout groove 53 (second groove) provided at the fitting part 51 of the case 50a. By dividing the ventilation route into two grooves in this way, it is possible to suppress complexity of a die for the plate 40a and a die for the case 50a, so it is easy to manufacture the dies.

### Third Embodiment

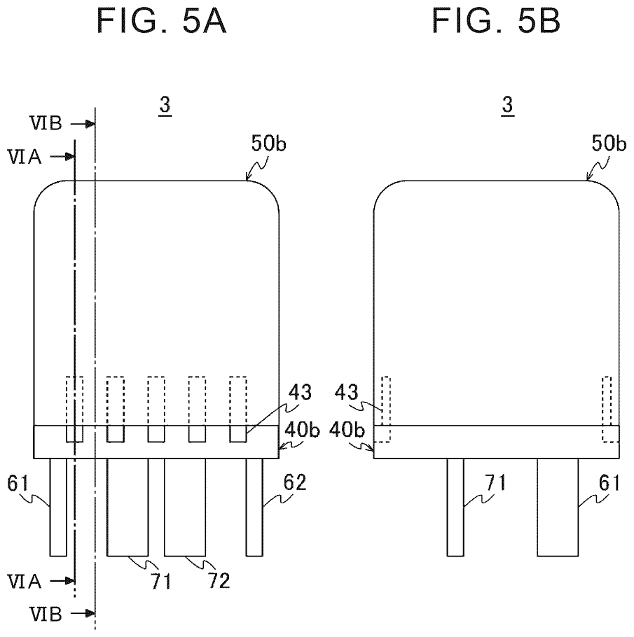

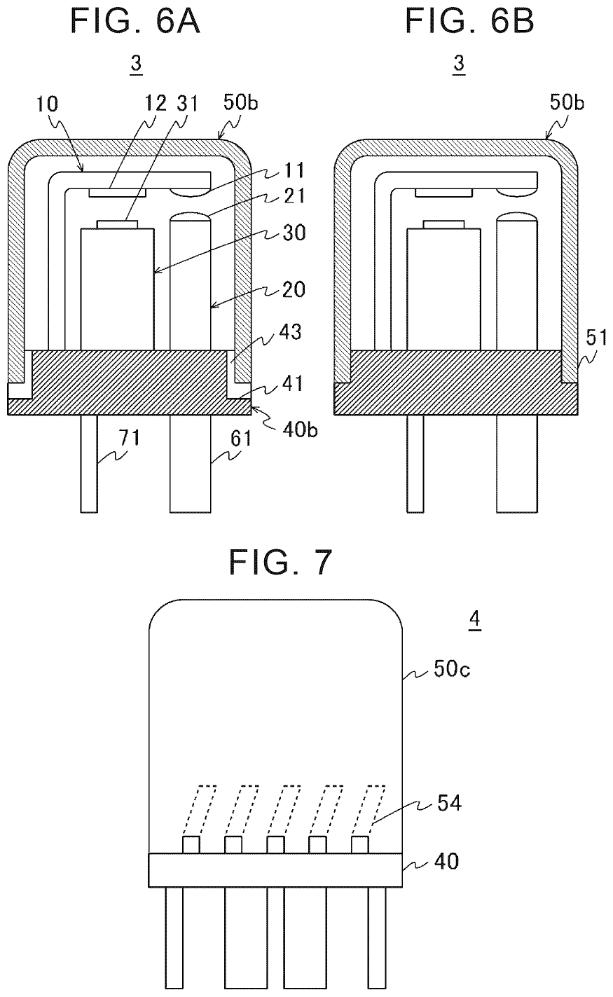

FIG. 5A is a front view of an electromagnetic relay 3 according to a third embodiment of the disclosure when viewed from the surface. FIG. 5B is a side view of the electromagnetic relay 3 according to the third embodiment of the disclosure when viewed from the surface. FIG. 6A is a sectional view of the electromagnetic relay 3, taken along the line VIA-VIA in FIG. 5A. FIG. 6B is a sectional view of the electromagnetic relay 3, taken along the line VIB-VIB in FIG. 5A.

The electromagnetic relay 3 illustrated in FIG. 5A, FIG. 5B, FIG. 6A, and FIG. 6B is a switch component for switching action of electrical contacts by using electromagnetic force. The electromagnetic relay 3 includes a movable contact part 10, a fixed contact part 20, an electromagnetic coil 30, a plate 40b, a case 50b, load terminals 61, 62, and coil terminals 71, 72.

The electromagnetic relay 3 according to the third embodiment differs from the electromagnetic relay 1 according to the first embodiment in the configurations of the plate 40b and the case 50b. Hereinafter, the description of the functional unit made up of the movable contact part 10, the fixed contact part 20, and the electromagnetic coil 30 each having the same configuration is omitted, and the description of the plate 40b and the case 50b each having a different configuration will be described.

The plate 40b is a member having substantially a rectangular plate shape in a top view and made of a material, such as a resin, having electrical insulating properties. The movable contact part 10, the fixed contact part 20, and the electromagnetic coil 30 are mounted on a first flat surface (upper surface) of the plate 40b. The load terminal 61, the load terminal 62, the coil terminal 71, and the coil terminal 72 are provided on a second flat surface (lower surface) of the plate 40b so as to be allowed to be electrically joined with another component. A step 41 with a predetermined depth for being fitted to the case 50b is provided at the outer periphery of the first flat surface of the plate 40b.

The plate 40b according to the third embodiment, in addition to the above-described structure, further includes a ventilation route 43 for releasing moisture generated inside the electromagnetic relay 3, the inside of which is formed by the plate 40b and the case 50b, to outside the electromagnetic relay 3. The ventilation route 43 is made up of a groove obtained by cutting the step 41 of the plate 40b into an L-shape and a cutout groove extending from the groove to the first flat surface (upper surface) along an outer surface of the plate 40b in a state where the case 50b is fitted to the plate 40b. With the presence of the ventilation route 43, it is possible to release moisture generated inside the electromagnetic relay 3 to outside by communicating the inside of the electromagnetic relay 3 with the outside of the electromagnetic relay 3 in a state where the functional unit that executes the electromagnetic relay process is protected by the case 50b from foreign matter or contaminants.

Of course, in the electromagnetic relay 3 as well, the number of sides each having the ventilation route 43, and the location and shape of the ventilation route 43 are not limited to those shown in FIG. 5A, FIG. 5B, FIG. 6A, and FIG. 6B. It is also desirable to give a higher priority to ventilation for the electromagnetic coil 30 than ventilation for the movable contact part 10 or the fixed contact part 20 or to narrow the passage size of each ventilation route 43 at least at one location as compared to the height of a specific bug.

As described above, in the electromagnetic relay 3 according to the third embodiment, the ventilation route 43 for releasing moisture from the inside of the electromagnetic relay 3 in a state where the plate 40b and the case 50b are fitted to each other is provided at the step 41 of the plate 40b. As in the case of this structure, when the ventilation route 43 is provided at the plate 40b higher in mechanical strength (thicker) than the case 50b, it is possible to avoid a decrease in mechanical characteristics.

### Other Embodiments

FIG. 7 is a front view of an electromagnetic relay 4 according to a first modification of the first embodiment of the disclosure when viewed from the surface. The electromagnetic relay 4 according to the first modification illustrated in FIG. 7 has a structure in which the case 50 of the electromagnetic relay 1 according to the first embodiment is replaced with a case 50c.

The case 50c includes a ventilation route 54 for releasing moisture generated inside the electromagnetic relay 4 to outside. The ventilation route 54, as in the case of the ventilation route 52 of the electromagnetic relay 1, is made up of a hole obtained by cutting part of the fitting part 51 of the case 50c into a U-shape and a linear cutout groove provided on the inner surface of the case 50c from the hole in a state where the case 50c is fitted to the plate 40. However, the electromagnetic relay 4 differs from the electromagnetic relay 1 in the length of the cutout groove.

Specifically, in the electromagnetic relay 1 according to the first embodiment, the ventilation route 52 that connects the inside of the electromagnetic relay 1 to the outside of the electromagnetic relay 1 with the shortest distance and that is perpendicular to the first flat surface (upper surface) of the plate 40 is provided. In contrast, the ventilation route 54 of the electromagnetic relay 4 according to the first modification is formed in a shape to connect the inside of the electromagnetic relay 4 with the outside of the electromagnetic relay 4 with a selected angle with respect to the first flat surface of the plate 40. The angle of the ventilation route 54 is not limited.

With the above-described shape, the distance of the ventilation route 54 of the electromagnetic relay 4 according to the first modification is longer than the distance of the ventilation route 52 of the electromagnetic relay 1 according to the first embodiment. Thus, with the electromagnetic relay 4 according to the first modification, it is possible to further reduce entry of foreign matter or contaminants into the electromagnetic relay 4 as compared to the electromagnetic relay 1 according to the first embodiment.

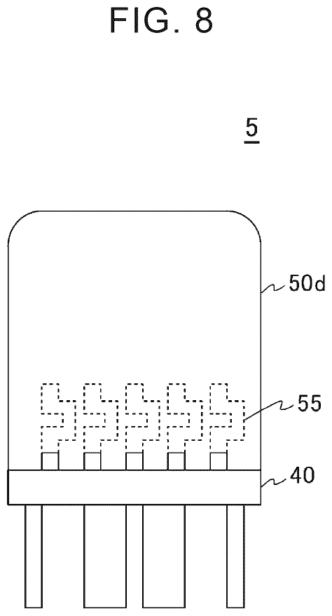

FIG. 8 is a front view of an electromagnetic relay 5 according to a second modification of the first embodiment of the disclosure when viewed from the surface. The electromagnetic relay 5 according to the second modification illustrated in FIG. 8 has a structure in which the case 50 of the electromagnetic relay 1 according to the first embodiment is replaced with a case 50d.

The case 50d includes a ventilation route 55 for releasing moisture generated inside the electromagnetic relay 5 to outside. The ventilation route 55, as in the case of the ventilation route 52 of the electromagnetic relay 1, is made up of a hole obtained by cutting part of the fitting part 51 of the case 50d into a U-shape and a cutout groove provided on the inner surface of the case 50d from the hole in a state where the case 50d is fitted to the plate 40. However, the electromagnetic relay 5 differs from the electromagnetic relay 1 in the shape of the cutout groove.

Specifically, in the electromagnetic relay 1 according to the first embodiment, the ventilation route 52 having a shape in which the inside and outside of the electromagnetic relay 1 are connected by a linear path. In contrast, in the electromagnetic relay 5 according to the second modification, the ventilation route 55 has a shape in which the inside and outside of the electromagnetic relay 5 are connected by a nonlinear path. The ventilation route 55 is not limited to a shape bent in a U-shape illustrated in FIG. 8. Various nonlinear paths, such as a crank shape and a curved shape, may be adopted.

With the above-described shape, the distance of the ventilation route 55 of the electromagnetic relay 5 according to the second modification is longer than the distance of the ventilation route 52 of the electromagnetic relay 1 according to the first embodiment. Thus, with the electromagnetic relay 5 according to the second modification, it is possible to further reduce entry of foreign matter or contaminants into the electromagnetic relay 5 as compared to the electromagnetic relay 1 according to the first embodiment. Since the ventilation route 55 is bent halfway, when the interval of bending is appropriately adjusted according to the body length of a bug (for example, the body length of scirtothrips dorsalis: about 0.7 mm), it is possible to enhance protection against entry of the bug into the electromagnetic relay 5.

A method of forming the ventilation route according to the first modification and a method of forming the ventilation route according to the second modification are also applicable to the electromagnetic relay 2 according to the second embodiment and the electromagnetic relay 3 according to the third embodiment. In other words, the cutout groove 42 of the plate 40a and the cutout groove 53 of the case 50a in the electromagnetic relay 2 may be linearly formed at an angle with respect to the first flat surface of the plate 40a or may be formed nonlinearly. The ventilation route 43 provided at the step 41 of the plate 40b in the electromagnetic relay 3 may be formed linearly at an angle with respect to the first flat surface of the plate 40b or may be formed nonlinearly.

### Advantageous Effects

As described above, with the structure of the electromagnetic relay according to the embodiments of the disclosure, a groove is provided at the joint area between the plate and the case, so it is easy to adjust the opening size or the opening area, and no minute male die is required for the ventilation route. Since the ventilation route is provided at a location apart from the terminals, it is possible to reduce a situation in which foreign matter or contaminants flow along the terminals and enter and reach the contacts. Furthermore, since a large number of ventilation routes can be disposed in a distributed manner, moisture inside the electromagnetic relay is effectively and easily released to outside.

The electromagnetic relay according to the disclosure is useful in, for example, a case where moisture inside the electromagnetic relay is intended to be effectively released to outside.

What is claimed is:

1. An electromagnetic relay comprising:
a functional unit configured to execute an electromagnetic relay process;
a plate having a flat shape, the functional unit being mounted on the plate; and
a case having a box shape and covering the functional unit when fitted to the plate, wherein
the case has a ventilation route at a fitting part that contacts with the plate when the case is fitted to the plate, the ventilation route communicating an inside of the electromagnetic relay, in which the functional unit is present, with an outside of the electromagnetic relay.

2. The electromagnetic relay according to claim 1, wherein the ventilation route has a distance longer than a shortest distance between the inside of the electromagnetic relay and the outside of the electromagnetic relay.

3. The electromagnetic relay according to claim 2, wherein the ventilation route is made up of a nonlinear path.

4. The electromagnetic relay according to claim 2, wherein the ventilation route is preferentially provided near an electromagnetic coil that is a component of the functional unit.

5. The electromagnetic relay according to claim 2, wherein a passage size of the ventilation route at least at one location is less than 0.1 mm.

6. An electromagnetic relay comprising:
a functional unit configured to execute an electromagnetic relay process;
a plate having a flat shape, the functional unit being mounted on the plate; and
a case having a box shape and covering the functional unit when fitted to the plate, wherein:
the plate has a first groove;
the case has a second groove; and
a ventilation route is provided by combining the first groove with the second groove when the plate and the case are fitted to each other, the ventilation route communicating an inside of the electromagnetic relay, in which the functional unit is present, with an outside of the electromagnetic relay.

7. The electromagnetic relay according to claim 6, wherein the ventilation route has a distance longer than a shortest distance between the inside of the electromagnetic relay and the outside of the electromagnetic relay.

8. The electromagnetic relay according to claim 7, wherein the ventilation route is made up of a nonlinear path.

9. The electromagnetic relay according to claim 7, wherein the ventilation route is preferentially provided near an electromagnetic coil that is a component of the functional unit.

10. The electromagnetic relay according to claim 7, wherein a passage size of the ventilation route at least at one location is less than 0.1 mm.

11. An electromagnetic relay comprising:
a functional unit configured to execute an electromagnetic relay process;
a plate having a flat shape, the functional unit being mounted on the plate; and
a case having a box shape and covering the functional unit when fitted to the plate, wherein
the plate has a ventilation route at a step with which the case contacts when the plate is fitted to the case, the ventilation route communicating an inside of the electromagnetic relay, in which the functional unit is present, with an outside of the electromagnetic relay.

12. The electromagnetic relay according to claim 11, wherein the ventilation route has a distance longer than a shortest distance between the inside of the electromagnetic relay and the outside of the electromagnetic relay.

13. The electromagnetic relay according to claim 12, wherein the ventilation route is made up of a nonlinear path.

14. The electromagnetic relay according to claim 12, wherein the ventilation route is preferentially provided near an electromagnetic coil that is a component of the functional unit.

15. The electromagnetic relay according to claim 12, wherein a passage size of the ventilation route at least at one location is less than 0.1 mm.
